(19) United States
(12) Patent Application Publication
(10) Pub. No.: US 2002/0152157 A1
(43) Pub. Date: Oct. 17, 2002

(54) Computerized retail finance program selection systems and methods

(76) Inventors: Atanas Stoyanov, Thousand Oaks, CA (US); Ryan DeLaet, Thousand Oaks, CA (US); Damion Moyer-Sims, Portland, OR (US); Clifford Drew Wells, Westlake Village, CA (US); Russell West, Camarillo, CA (US); Russell G. West, Agoura Hills, CA (US); David Bartels, Westlake Village, CA (US)

Correspondence Address: OPPENHEIMER WOLFF & DONNELLY LLP, Suite 3800, 2029 Century Park East, Los Angeles, CA, 90067, US

(21) Appl. No.: 10/057,436

(22) Filed: Jan. 25, 2002

Related U.S. Application Data
(60) Provisional application No. 60/264,595, filed on Jan. 25, 2001.

(51) Int. Cl. G06F 17/60

(52) U.S. Cl. 705/38

(57) ABSTRACT

Systems and methods for enabling automobile dealers to select a loan for a prospective customer are disclosed. The selection is made from an extensive database of loans comprising loan packages from a plurality of financial institutions and other sources. The selection is determined according to a series of complex calculations designed to meet customer criteria, maximize dealer profit, and minimize waiting-time.

### RELATED APPLICATIONS This Application claims priority of U.S. Provisional Application No. 60/264,595 filed Jan. 25, 2001, incorporated herein by reference.

### BACKGROUND OF THE INVENTION

1. Field of the Invention

This invention relates to consumer loan qualification and selection systems and methods. More particularly, the invention relates to computerized systems and methods identifying loan packages available to a customer based on his or her individual qualifications coupled with a seller's profit objectives.

2. General Background and State of the Art

Automobile sales and finance have made significant progress in the marketplace in recent years. A booming economy has provided consumer confidence and, in turn, increased sales in the automotive industry. Recent advances in technology, including the instantaneous nature of the “virtual world” experienced over the Internet, is providing additional impetus for a move toward further modernization of the automobile sales industry. As society becomes increasingly accustomed to immediate service and instant results, as is now commonly provided by on-line retailers in many consumer markets, there is a need in the auto sales industry to develop new methods for providing service that is also immediate and satisfactory to its customers.

Customers appreciate the added service that is offered by automobile dealers who are able to provide loans, hereinafter referred to as retail finance packages, to their customers. The added offering is beneficial to the dealers as well, as profit can be made not only on the sale of the automobile, but on the sale of the retail finance package as well. Unfortunately, these additional offerings of retail finance programs by automobile dealers are significantly limited in several ways.

Often, dealers are unable to offer a large variety of retail finance sources, such as through banks, credit unions, or other independent financial institutions. The infrastructure required for an automobile dealer to offer such options would be extremely burdensome, as it would require careful tracking and organization of innumerable criteria and data related to such financing programs. As a result, many automobile dealers offer financing funded by the automobile company itself.

Those automobile dealers who are able to offer alternate financing programs, generally may only offer a limited fraction of all that is truly available. Auto dealers do not currently have the means by which to access every retail finance program from every financial institution. Rather, any single automobile dealer only knows of and has access to a limited number of financial institutions' retail finance programs.

Even those automobile dealers who are able to access a limited number of financial institutions' retail finance programs face a significant obstacle of timeliness. Generally, when accessing an outside financial institution for a retail finance program, the automobile dealer acts as a “middle man” between the customer and the financial institution, passing information back and forth between the two parties. This exchange of information, as well as the reliance on the financial institution to consider the customer's information and approve or deny the customer for financing, requires a certain amount of processing time. The processing time translates into waiting time from the customer's perspective. The more time that is required, the more likely the customer is to become impatient and seek his own financing elsewhere.

The time constraint explained above also impacts the effectiveness of the dealer's retail finance program sales by making it difficult, or impossible, for a dealer to identify the “best” retail finance program for his customer in the limited amount of time available for calculating and searching for a retail finance program. A significant number of variables enters into calculations involving retail finance programs. These variables include some attributable to the retail finance program itself, and some attributable to a customer. Because customer-related variables, such as the amount of cash a customer has available to use on a down payment or the amount of money the customer can afford to spend on a monthly payment, cannot be determined until the time the customer engages in negotiations with the dealer, these complicated retail finance program calculations cannot be performed ahead of time. The dealer must perform the calculations while the customer is waiting. Because of the large number of variables and the limited amount of time, dealers may be unable to optimize the variables and identify the best retail finance program for the customer.

In addition to time constraints, current calculation methods available to auto dealers may limit the dealers' ability to optimize retail finance program selection. For example, existing retail finance program comparison methods typically require dealers to use a fixed down payment amount as a basis for comparison between lenders and their retail finance programs. However, down payments are only one portion of the up-front fees required from a customer at the inception of a retail finance program. Other fees will include, for example, finance inception fees, taxes, and registration and license fees. These additional fees typically affect the suitability of a particular retail finance program to a particular customer, yet dealers are currently unable to consider the effects of these fees when selecting a retail finance program for the customer. Generally, only after a retail finance program has been selected, are the additional inception fees considered. At that point, should the inception fees cause the selected retail finance program to be too burdensome for the customer, the dealer must select another retail finance program. This process is inefficient and time consuming. Moreover, it fails to allow dealers to consider certain important data when selecting retail finance programs for their customers.

In addition to not allowing dealers to consider important variables, such as various inception fees, when comparing retail finance programs for the purpose of selecting the best retail finance program for a customer, prior art methods typically do not allow dealers to compare retail finance programs according to paid reserve. This is a significant drawback for a dealer when selecting a retail finance program most beneficial to the dealer, because paid reserve amounts are a substantial portion of any financial gain a dealer will receive in the execution of a deal. Currently, however, dealers compare retail finance programs on the basis of single components of a paid reserve, rather than on the entire paid reserve amount. Therefore, dealers may not always have the ability to select the most profitable retail finance program.

What is needed is a way for automobile dealers to offer their customers (1) a wide array of financing options that benefit both the customer's budget requirements and the dealer's profit goals (2) in a relatively short time period designed to minimize a customer's waiting time (3) while considering a plurality of data that bear on the applicability of financing options to the customer. Such a system would provide customers with viable retail finance options immediately and without delay, and would provide the automobile dealer both the added profit gained by selling retail finance programs as well as indications of the which leases will provide the highest profit.

### INVENTION SUMMARY

The present invention includes a computerized system that helps auto dealers select a retail finance program for a prospective customer that meets the criteria of the customer (e.g. a monthly payment), while maximizing the profit which the dealer makes in the transaction. The retail finance programs available to the auto dealer comprise an extensive database that is far-reaching and continually updated. The complex calculations are designed to locate retail finance programs that will generate the most substantial profit for the auto dealer. This combination of calculations maximizes efficiency and reduces the customer's waiting time by providing prompt results.

The large number of criteria that go into calculating the customer's costs and dealer profits in connection with each retail finance program, coupled with the large number of retail finance program and retail finance programs that are available, makes it very difficult, as a practical matter, for a dealer to select the retail finance program that represents the best deal for the customer and/or provides the most profit for the dealer. As a consequence, a retail finance program is often selected that is less than optimal.

The invention includes a computerized system that methodically examines an entire database of retail finance programs and selects the ones that are optimal for the customer and/or the dealer. The invention encompasses multiple related methods for identifying and selecting optimal retail finance programs.

The invention is directed, in part, to the concept of a computerized system that considers upward adjustments in the sales price of the vehicle as a means for locating the optimal retail finance program when the inception fees which a buyer must pay (e.g., the first payment, security deposit, bank fees, registration fees, documentation fees) cannot exceed a certain amount. The monthly payment a buyer must make for a retail finance program is dependent upon the amount of customer cash paid at inception. In many cases, however, a buyer cannot afford to pay more than a certain portion of the inception fees. This, in turn, can lead to a high monthly payment. In some cases, however, a lower monthly payment can be realized by increasing the interest rate of the retail finance program (according to the lender's policies) and waiving a portion of the inception fees. This new feature of the invention implements this concept in an automated fashion to better locate the optimal retail finance program. While systems and methods of the prior art compare only down payment amounts between retail finance programs, and require varying amounts of customer cash between different lenders and their retail finance programs, the systems and methods of the present invention enable a dealer to compare lenders and their retail finance programs based on available customer cash.

A second feature of the invention includes for the computer system to search through the inventory of vehicles that are on a dealer's lot to find the ones that meet various retail finance program or customer criteria. This feature is actually far more complicated than might be imagined at first. Part of the reason is because the terms which a lessor provides often vary as a function of the particular vehicle. A dealer may enter a desired profit and search for vehicles and associated retail finance programs having the lowest monthly payment. Conversely, a dealer may enter a desired monthly payment and search for vehicles and associated retail finance programs having the highest profit.

A third feature of the invention involves the computer system allowing the dealer to search for retail finance programs that meet a specified “paid reserve” amount. As is well known in the auto industry, “paid reserve” is money which the or lessor pays back to the dealer as a type of commission. Sometimes, the “paid reserve” is a fixed percentage of the vehicle price. Other times, it depends upon the “money factor” for retail finance programs, which the dealer can procure from the customer. Thus, if the dealer can procure a higher money factor, the dealer will receive a higher “paid reserve.” This feature not only identifies retail finance programs that will yield a specified paid reserve, but also calculates for the dealer what money factor must be applied to each of the programs in order to yield that paid reserve. This enables a dealer to select a retail finance program the represents the best deal for the customer, while providing the dealer with a specified paid reserve.

A fourth feature of the invention, applicable only to retail finance program systems, is that the dealer can fix the selling price for a vehicle and the computer will identify lessors who can offer retail finance programs yielding the highest profits. Sometimes, a buyer will tell the dealer that the buyer is only willing to pay a certain price over the factory invoice. This feature of the invention allows the dealer to meet this limitation, without sacrificing the needed amount of profit. The dealer instructs the computer to find all retail finance programs for the vehicle at the price specified by the customer, while maximizing other factors such as the paid reserve and the warranty price to maximize the dealer's profit.

The foregoing and other objects, features, and advantages of the present invention will be become apparent from a reading of the following detailed description of exemplary embodiments thereof, which illustrate the features and advantages of the invention in conjunction with references to the accompanying drawing Figures.

### BRIEF DESCRIPTION OF THE DRAWINGS

FIG. 1 is a flow diagram illustrating steps of a first, profit scan embodiment of the present invention.

FIG. 2 is a flow diagram illustrating steps of a second, payment scan embodiment of the present invention.

FIG. 3 is a flow diagram illustrating steps of a third, custom scan embodiment of the present invention.

FIG. 4 is a flow diagram illustrating steps of a fourth, maximized scan embodiment of the present invention.

FIG. 5 is a flow diagram illustrating steps of a fifth, profit search embodiment of the present invention.

FIG. 6 is a flow diagram illustrating steps of a sixth, payment search embodiment of the present invention which.

FIG. 7 is a flow diagram illustrating steps of a seventh, maximized search embodiment of the present invention.

FIG. 8 is a flow diagram illustrating steps of a eighth, paid reserve calculation embodiment of the present invention.

FIG. 9 is a flow diagram illustrating steps of a ninth, fixed paid reserve scan embodiment of the present invention.

FIG. 10 is a flow diagram illustrating steps of a tenth, rate adjustment calculation embodiment of the present invention.

FIG. 11 illustrates an exemplary computer system on which various embodiments of the present invention may be practiced.

### DETAILED DESCRIPTION OF THE PREFERRED EMBODIMENTS

In the following description of the preferred embodiments reference is made to the accompanying drawings which form the part thereof, and in which are shown by way of illustration specific embodiments in which the invention may be practiced. It is to be understood that other embodiments may be utilized and structural and functional changes may be made without departing from the scope of the present invention.

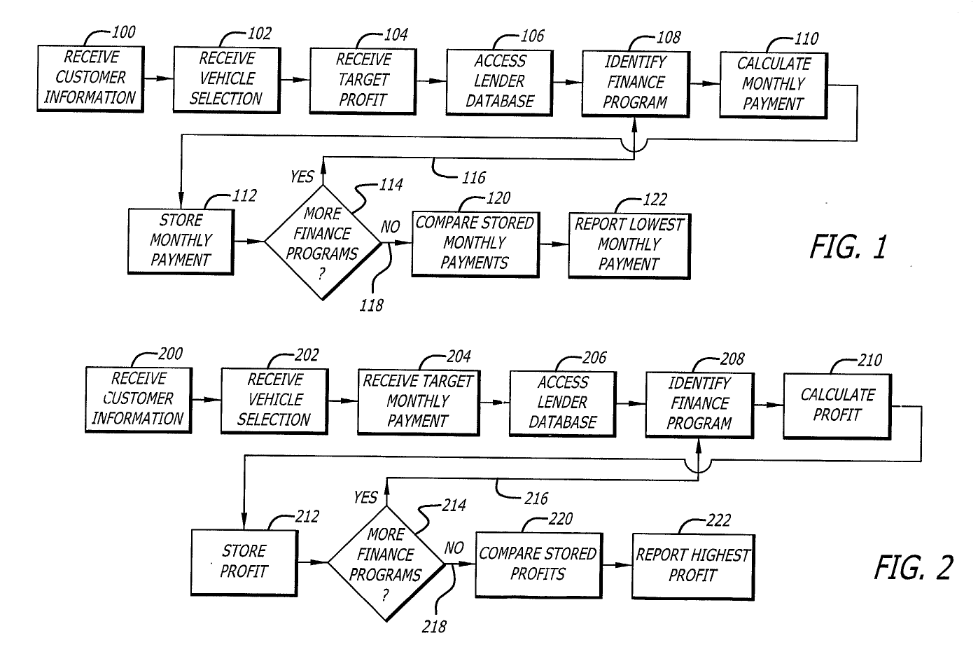

FIG. 1 is a flow diagram illustrating steps of a first, profit scan embodiment of the present invention. As used herein, the term “scan” refers generally to a query and set of calculations conducted by systems and methods of the present invention for a single vehicle. In the first embodiment, a dealer collects customer information including personal data and financial data. The customer information is entered by the dealer into a computer running software designed according to this first embodiment. The entered information is received by the software, as indicated at block 100. The dealer also enters the customer's vehicle selection, which the customer has chosen from the dealer's lot as the vehicle he wishes to purchase. After the vehicle selection is received at block 102, the dealer enters the profit he would like to make on the deal, the target profit, at block 104. Once the software receives the above information, it causes the computer to access a lender database, at block 106. The lender database stores information about the retail finance programs offered by the lender and available for the dealer to offer to his customers. Alternatively, the database accessed at block 106 may be a local database located at the dealer's location and regularly updated by information received from the lender database.

After accessing information from the list of available retail finance programs, the exemplary method is used to identify which of them will offer the lowest monthly payment based upon the customer information, vehicle selection and target profit constraints. Specifically, a first retail finance program is identified, at block 108, for evaluation. At block 110, the software calculates the monthly payment required by the identified retail finance program as applied to the customer information, vehicle selection and target profit constraints. The calculated monthly payment is stored at block 112, such as in a temporary computer file. At block 114, the software determines whether additional retail finance programs are in the list and have yet to be evaluated. If yes, as indicated by arrow 116, the next retail finance program in the list is identified and the monthly payment calculation repeats.

After the monthly payment has been calculated and stored for each of the available retail finance programs, and the answer at block 114 is no, as indicated by arrow 118, the software compares the stored monthly payments, at block 120. After comparing the stored monthly payments, the software identifies the lowest monthly payment and, at block 122, reports to the dealer which of the available retail finance programs offers the customer the lowest monthly payment.

FIG. 2 is a flow diagram illustrating steps of a second, payment scan embodiment of the present invention. In the second embodiment, a dealer again collects customer information including personal data and financial data. The customer information is entered by the dealer into a computer running software designed according to this second embodiment. The entered information is received by the software, as indicated at block 200. The dealer also enters the customer's vehicle selection, which the customer has chosen from the dealer's lot as the vehicle he wishes to purchase. After the vehicle selection is received at block 202, the dealer enters the monthly payment requested by the customer, the target monthly payment, at block 204. Once the software receives the above information, it causes the computer to access a lender database, at block 206.

After accessing information from the list of available retail finance programs, the exemplary method is used to identify which of them will yield the highest profit based upon the customer information, vehicle selection and target monthly payment constraints. Specifically, a first retail finance program is identified, at block 208, for evaluation. At block 210, the software calculates the profit generated by the identified retail finance program as applied to the customer information, vehicle selection and target monthly payment constraints. The profit calculation includes maximizing the amount of profit that can be generated by the identified retail finance program under the constraints described above. Maximizing the profit may include, for example, increasing the vehicle sale price or making upward adjustments in the sale price of other profit sources, such as warranty. The calculated profit is stored at block 212, such as in a temporary computer file. At block 214, the software determines whether additional retail finance programs are in the list and have yet to be evaluated. If yes, as indicated by arrow 216, the next retail finance program in the list is identified and the profit calculation repeats.

After the profit has been calculated and stored for each of the available retail finance programs, and the answer at block 214 is no, as indicated by arrow 218, the software compares the stored profits, at block 220. After comparing the stored profits, the software identifies the highest profit and, at block 222, reports to the dealer which of the available retail finance programs will generate the highest profit.

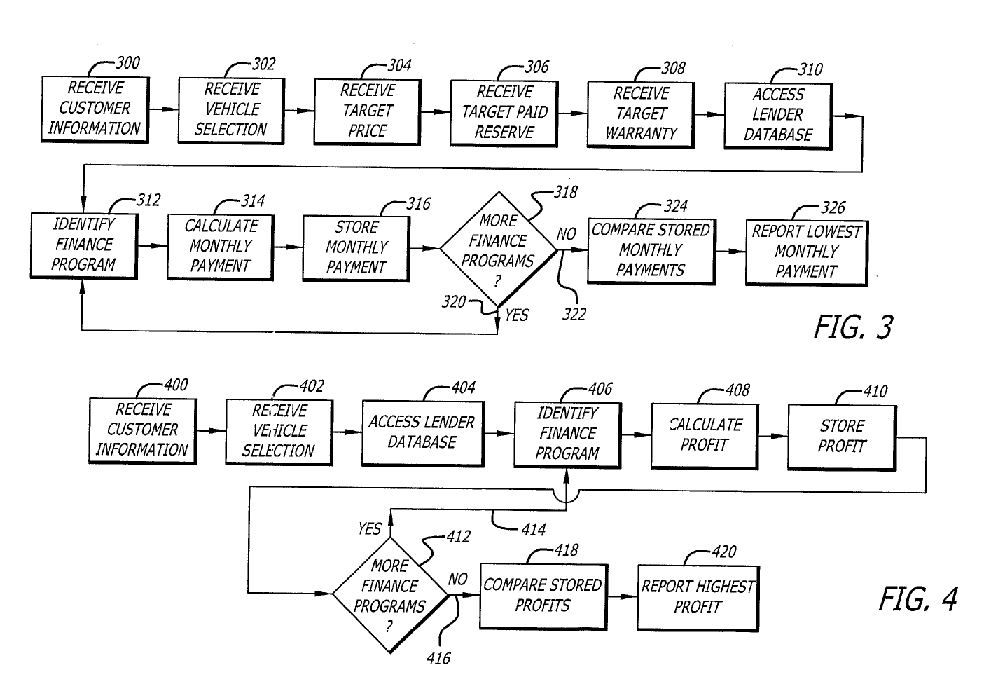

FIG. 3 is a flow diagram illustrating steps of a third, custom scan embodiment of the present invention. In the custom scan embodiment, a dealer fixes the selling price for a particular vehicle. The software of the custom scan embodiment manipulates paid reserve and warranty pricing variables, and identifies available lenders that can offer finance programs yielding the lowest monthly payments. This embodiment is particularly useful to dealers when customers have knowledge of a vehicle's invoice price and are willing to pay a fixed amount above the invoice price. The dealer has the ability, with this embodiment, to fix the selling price for the vehicle at the customer's offer price, and the software calculates the monthly payment according to paid reserve and warranty prices, without manipulating the vehicle selling price.

First, the dealer enters customer information, which is received into the software at block 300. The dealer also enters the customer's vehicle selection, at block 302, and the target price requested by the customer, at block 304. Additionally, the dealer enters a target paid reserve amount at block 306, and a target warranty price at block 308. Paid reserve amounts are a profit source for the dealer, as will be described in detail below, in other embodiments of the present invention. Warranties are also a profit source for the dealer. It is, of course, anticipated that other profit sources may be entered by the dealer into the software at this point in the exemplary method.

After all the information is received, the software accesses the lender database at block 310. After accessing information from the list of available retail finance programs, the exemplary method is used to identify which of them will offer the lowest monthly payment based upon the customer information, vehicle selection, target profit, target paid reserve and target warranty constraints. Specifically, a first retail finance program is identified, at block 312, for evaluation. At block 314, the software calculates the monthly payment required by the identified retail finance program as applied to the customer information, vehicle selection and target profit constraints. The calculated monthly payment is stored at block 316, such as in a temporary computer file. At block 318, the software determines whether additional retail finance programs are in the list and have yet to be evaluated. If yes, as indicated by arrow 320, the next retail finance program in the list is identified and the monthly payment calculation repeats.

After the monthly payment has been calculated and stored for each of the available retail finance programs, and the answer at block 318 is no, as indicated by arrow 322, the software compares the stored monthly payments, at block 324. After comparing the stored monthly payments, the software identifies the lowest monthly payment and, at block 326, reports to the dealer which of the available retail finance programs offers the customer the lowest monthly payment.

FIG. 4 is a flow diagram illustrating steps of a fourth, maximized scan embodiment of the present invention. In the maximized scan embodiment, software searches for the retail finance program that yields the highest profit, with no target profit or target monthly payment constraints. First, a dealer collects customer information including personal data and financial data. The customer information is entered by the dealer and received by the software, as indicated at block 400. The dealer also enters the customer's vehicle selection, which the customer has chosen from the dealer's lot as the vehicle he wishes to purchase. After the vehicle selection is received at block 402, the software causes the computer to access a lender database, at block 404.

After accessing information from the list of available retail finance programs, the exemplary method is used to identify which of them will yield the highest profit based upon the customer information, vehicle selection and target monthly payment constraints. Specifically, a first retail finance program is identified, at block 406, for evaluation. At block 408, the software calculates the profit generated by the identified retail finance program as applied to the customer information, vehicle selection and target monthly payment constraints. The profit calculation includes maximizing the amount of profit that can be generated by the identified retail finance program under the constraints described above. Maximizing the profit may include, for example, increasing the vehicle sale price or making upward adjustments in the sale price of other profit sources, such as warranty. The calculated profit is stored at block 410, such as in a temporary computer file. At block 412, the software determines whether additional retail finance programs are in the list and have yet to be evaluated. If yes, as indicated by arrow 414, the next retail finance program in the list is identified and the profit calculation repeats.

After the profit has been calculated and stored for each of the available retail finance programs, and the answer at block 412 is no, as indicated by arrow 416, the software compares the stored profits, at block 418. After comparing the stored profits, the software identifies the highest profit and, at block 420, reports to the dealer which of the available retail finance programs will generate the highest profit.

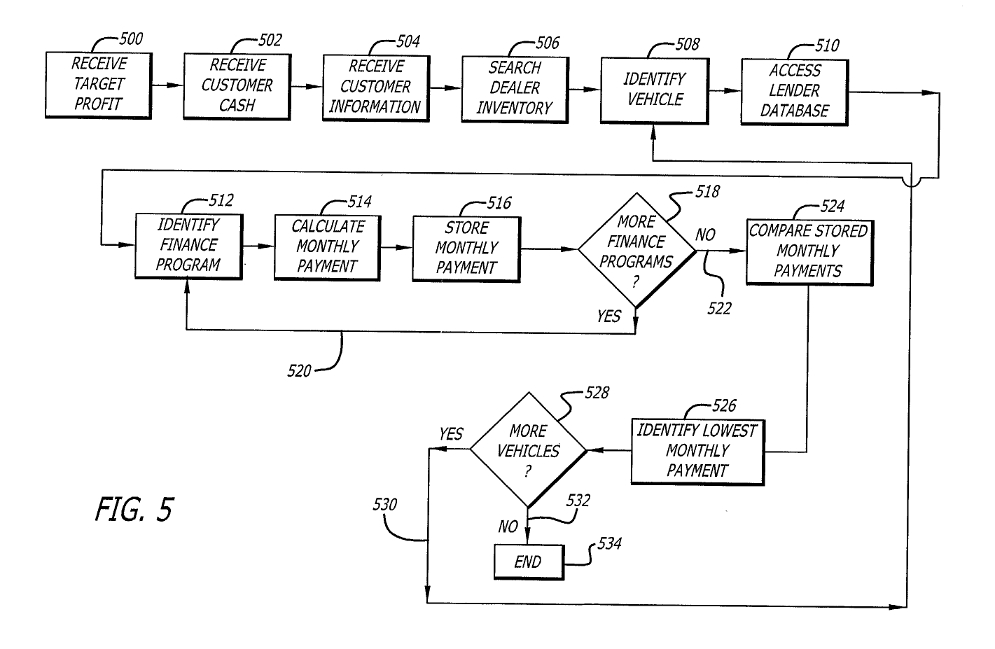

FIG. 5 is a flow diagram illustrating steps of a fifth, profit search embodiment of the present invention. This first embodiment involves a method in which, from a plurality of retail finance programs, the retail finance program requiring the lowest monthly payment for a fixed amount of customer cash is identified for each of a plurality of vehicles. More specifically, a dealer specifies a target profit he hopes to achieve in a deal, the amount of cash his customer has available to initiate the deal and other customer information. Using this information, the method of the present invention identifies, from among a plurality of available retail finance programs, the retail finance program requiring the lowest monthly payment of the customer.

As used herein, “customer cash” refers to the amount of money a customer offers for up-front payment at the inception of a lease program. Customer cash is typically applied to down payment, bank fees, registration fees, security deposit, documentation fees, and other inception fees. Also, as used herein, “customer information” refers to a customer's financial and personal data. This data may include information specific to a customer's financial history and used by credit bureaus to generate credit ratings. A customer's financial data, when utilized by embodiments of the present invention, typically are indicative of the likelihood of that customer being approved for a retail finance program.

Turning now to the specific steps performed in this fifth embodiment, and as indicated at block 500, the dealer enters, into a computer program, the target profit. The dealer also enters the amount of customer cash, shown at block 502, and other customer information, shown at block 504. As in all embodiments described herein, the entry of data may be performed with a keyboard or other peripheral device, and may be facilitated by a graphical user interface with fields presented to the dealer for receiving the information. Of course, other data entry methods are anticipated as being within the scope of the invention. Such methods include, but are not limited to, a magnetic media decoder that could, for example, be used to read information from a customer's drivers license, wireless transmission means to transmit data from a remote collection site to a main computer system, or a combination of both.

After the requisite information has been entered by the dealer and received by the system, the method of the first embodiment proceeds to search the dealer inventory of vehicles, as shown at block 506. Because the method identifies a retail finance program for each vehicle in the dealer's inventory, each vehicle is identified in turn, as shown at block 508. A lender database is then accessed, as shown at block 510. The lender database may include a plurality of retail finance programs available to the dealer. The method therefore analyzes each retail finance program in turn, beginning with the first retail finance program it identifies, as indicated at block 512. For the identified retail finance program, the software method of the fifth embodiment calculates a monthly payment as shown at block 514, given the amount of customer cash, other customer information, and requisite target profit that must be generated by the retail finance program for the dealer. The calculated monthly payment is stored, as shown at block 516, such as in a temporary file. The software then determines whether there are more retail finance programs to be evaluated, as indicated at block 518. If so, then as indicated by arrow 520, the next retail finance program is identified and the previously described process repeats. The process repeats until the answer determined at block 518 is negative, as indicated at arrow 522.

After all retail finance programs have been evaluated for the identified vehicle, the software compares the monthly payments it has stored, as indicated at block 524, and identifies the retail finance program that requires the lowest monthly payment at block 526. At block 528, the method determines whether there are additional vehicles in the dealer's inventory for which retail finance programs are to be evaluated. If so, then as indicated at arrow 530, the retail finance program evaluation routine previously described is performed for the next identified vehicle. In this manner, the retail finance program which requires the lowest monthly payment, given the entered customer cash and customer information, while generating the dealer's target profit, is identified for each car in the dealer's inventory. After the system identifies these retail finance programs for each car in the dealer's inventory, it determines that there are no more vehicles in the dealer's inventory, as indicated at arrow 532, and the process ends, as indicated at block 534.

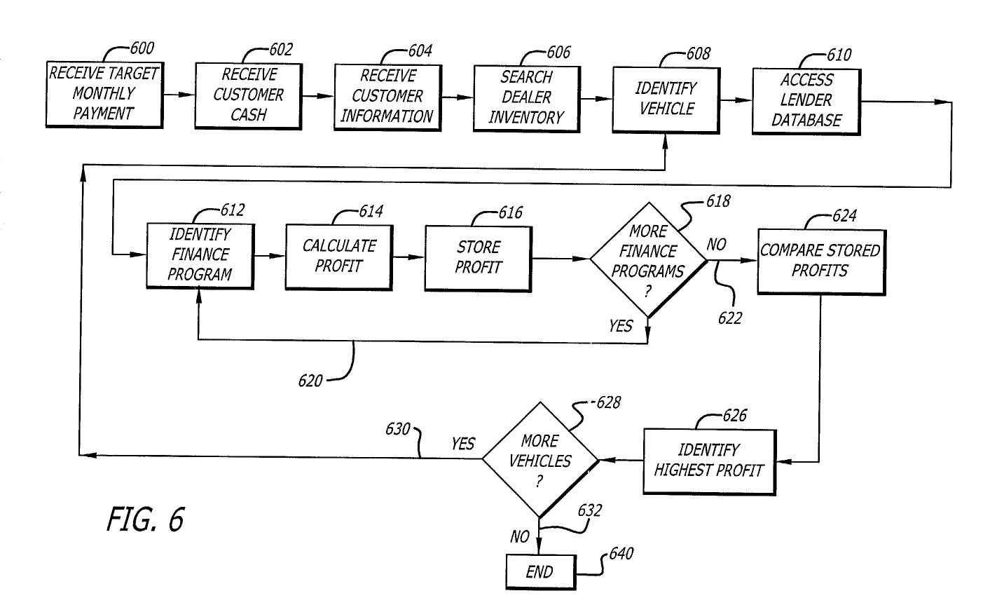

FIG. 6 is a flow diagram illustrating steps of a sixth, payment search embodiment of the present invention. This sixth embodiment involves a method in which, from a plurality of retail finance programs, the retail finance program yielding the highest dealer profit for a target monthly payment is identified for each of a plurality of vehicles. More specifically, the dealer enters a target monthly payment, such as the maximum monthly payment the customer is willing or able to make, and the method of the sixth embodiment identifies, from among a plurality of available retail finance programs, the retail finance program which generates the highest profit for the dealer.

In this sixth embodiment, the dealer enters a target monthly payment, the amount of available customer cash, and other customer information, as indicated at blocks 600, 602 and 604, respectively. The method then searches the dealer inventory of vehicles, as indicated at block 606. Within the searched inventory, a first vehicle is identified at block 608, and a lender database is accessed at block 610. From the available retail finance programs listed within the lender database, a first retail finance program is identified at block 612. At block 614, the software calculates the profit that will be generated by the identified retail finance program given the amount of available customer cash and required target monthly payment. The profit calculation includes maximizing the amount of profit that can be generated by the identified retail finance program under the constraints described above. Maximizing the profit may include, for example, increasing the vehicle sale price or making upward adjustments in the sale price of other profit sources, such as warranty. The calculated profit is stored at block 616, such as in a temporary file. At block 618 the program considers whether additional retail finance programs are available within the lender database. If so, then as indicated at arrow 620 the profit calculation routine is repeated for each available retail finance program, until the answer at block 618 is negative, as indicated at arrow 622.

After the profit is calculated for each available retail finance program for the identified vehicle, the stored profits are compared, at block 624, and the retail finance program which generates the highest profit is identified at block 626. At block 628, the software considers whether the dealer inventory includes more vehicles. If yes, as indicated by arrow 630, the retail finance program evaluation is repeated for the next identified vehicle, until the most profitable retail finance program is identified for every vehicle in the dealer's inventory. When there are no more vehicles to repeat the retail finance program evaluation routine for, as indicated at arrow 632, the process ends, as indicated at block 634.

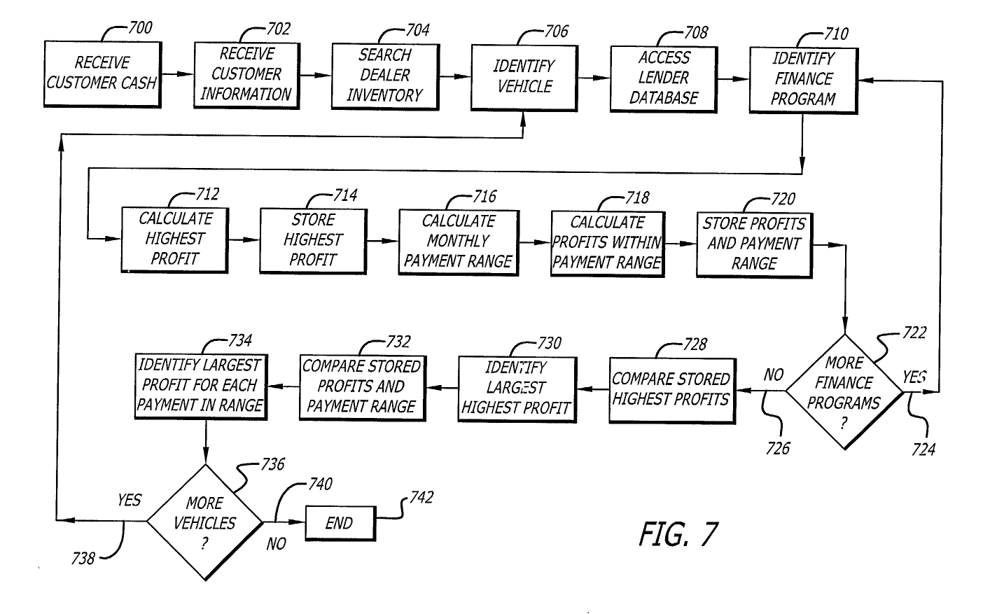

FIG. 7 is a flow diagram illustrating steps of a seventh, maximized search embodiment of the present invention. The seventh embodiment involves a method in which, from a plurality of retail finance programs, the retail finance program yielding the highest profit for a fixed amount of customer cash is identified for each of a plurality of vehicles and, with respect to each of the vehicles, for a plurality of various monthly payments. This embodiment allows a dealer to optimize several criteria in a single search. More specifically, a dealer enters only a fixed amount of customer cash, and the method of the invention identifies retail finance programs that optimize both the profit and the monthly payment.

Turning to the specific steps in the exemplary seventh embodiment, the dealer enters the amount of available customer cash, as indicated at block 700. The dealer also enters other customer information, at block 702. Upon receipt of this information, the software searches the dealer inventory, at block 704, and identifies a first vehicle, at block 706. The software then accesses, for that vehicle, a lender database that stores information about a plurality of retail finance programs, as indicated at block 708.

A first retail finance program is identified, at block 710, for which a profit and range of monthly payments will then be evaluated. First, at block 712, the highest possible profit capable of being produced by the identified retail finance program for the amount of available customer cash is calculated. This calculation involves solving for variables such that the profit generated by the lease program is maximized. While it may seem that the software would simply need to increase the sale price of the vehicle, warranty, and other such amounts in order to maximize the profit, and do so indefinitely, the profit maximizing calculations are actually bounded by limits of several of the variables. For example, each lender typically limits the amount of sale price it will finance. An example would be a lender who will finance a sale price of not more than 110% of the vehicles Manufacturer Suggested Retail Price (MSRP). Therefore, the software would be limited in any upward adjustment to the vehicle sale price by an upper bound of 110% of the vehicle's MSRP. Similarly, a lender may limit the interest rate spread it will allow. For example, a lender who limits an interest rate spread to 2% causes this limit to be imposed upon the software when it is attempting to maximize the amount of profit the lease program can generate. The profit maximizing calculations also include maximizing the profit on individual dealer options that are not included in the sale price of the vehicle. These options may include, for example, vehicle options and warranties.

For purposes of clarity, the term “rate spread” as used herein denotes the difference between a lender's rate (buy rate) and a dealer's rate after markup (sell rate). In lease programs, these rates are “money factors,” and the rate spread generates additional profit which may be allocated entirely to the dealer or split between the lender and the dealer.

After it is calculated, the highest profit is stored, at block 714, such as in a temporary file. Next, at block 716, a range of possible monthly payments is identified for the identified retail finance program, and selected monthly payment amounts are identified within the monthly payment range. At block 718, the profit which would be generated by the identified retail finance program for each of the monthly payment amounts identified at block 716 is calculated. These monthly payments and associated profits are then stored, at block 720.

After calculating the highest possible profit and the various profits generated for identified monthly payments for the identified retail finance program, the software considers at block 722 whether additional retail finance programs are within the lender database. If yes, as indicated at arrow 724, the profit calculation process repeats. In this manner, the profit potential for every available retail finance program is calculated, until the question at block 722 results in a negative answer. When the process has been performed for each available retail finance program, and there are no more retail finance programs to consider, as indicated at arrow 726, the software compares the stored highest profits, at block 728 and identifies which retail finance program generated the largest of the stored highest profits, at block 730. The software also compares the profits associated with the identified monthly payments, at block 732, and identifies for the dealer at block 734 which retail finance program generated the largest profit for each of the identified monthly payments. This information allows the dealer to present a wealth of valuable information to the customer, which can then be used by the customer or the dealer to select the best retail finance program.

Of course, the entire process may be repeated for each vehicle in the dealer's inventory. At block 736 the software determines whether additional vehicles are in the dealer's inventory. If so, as indicated by arrow 738, the process repeats for those vehicles Eventually, when there are no more vehicles to evaluate, as indicated at arrow 740, the process ends, at block 742.

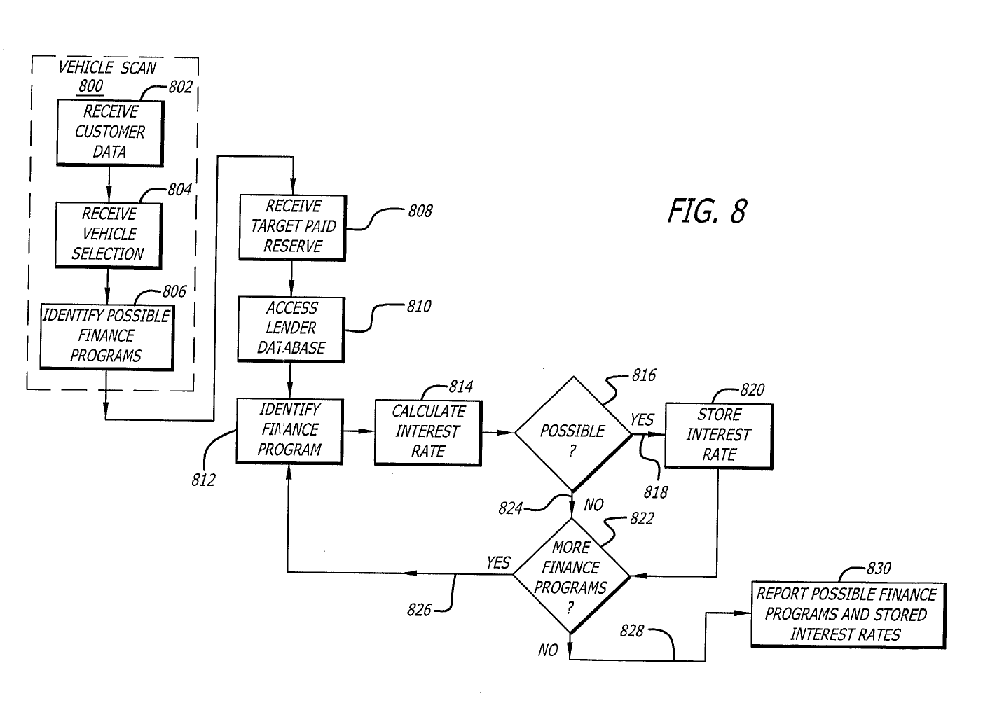

FIG. 8 is a flow diagram illustrating steps of an eighth, paid reserve calculation embodiment of the present invention. The eighth embodiment involves a method which, from a plurality of retail finance programs, identifies all retail finance programs capable of yielding a target paid reserve amount and, for each identified retail finance program, advises what interest rate must be used to yield the target paid reserve amount. Specifically, after running a vehicle scan, which will be explained in further detail below, a dealer determines and enters the amount of paid reserve he wants to make on the deal. This amount is the target paid reserve. The method of this eighth exemplary embodiment of the invention then accesses the lender database and identifies, for the dealer, which retail finance programs available therein are capable of generating the target paid reserve.

The term “paid reserve” as used herein refers to an amount of money paid by a lender to a dealer in exchange for the dealer selecting one of the lender's retail finance programs when making a deal with a customer. Calculating paid reserve amounts involves rate spread and rate participation.

The term “rate spread” as used herein refers to an interest increase applied by a dealer to a retail finance program offered by a lender. A rate spread, then, causes a customer to pay a higher amount of money over the term of the retail finance. The term “rate participation” as used herein is a percentage of the rate spread in which the dealer can participate. For example, a lender having a fifty percent participation rate would offer dealers a paid reserve amount equal to fifty percent of the difference in a customer's payments caused by the rate spread.

Returning to a description of paid reserve, these amounts typically calculated as a percentage of the anticipated difference in payments over the entire retail finance period caused by a rate spread. For example, if a retail finance term is 36 months, and the rate spread causes the customer's monthly payment to increase by $20 per month, the paid reserve will be the rate participation percentage multiplied by $20 multiplied by 36. Alternatively, paid reserve can be calculated as a percentage of the capitalized cost of a vehicle. Either way, the paid reserve amount is generally paid to the dealer at the time of a sale.

Finally, before returning to a discussion of the eighth method embodiment of the present invention, the specification will proceed with a description of a vehicle scan. A scan is a query and set of calculations conducted by the system for a single type of vehicle. Some of the steps included in a vehicle scan are identified in FIG. 8, at block 800. First a dealer enters customer data, which is received by a system performing the scan, at block 802. Next the dealer identifies which vehicle his customer is interested in, and this vehicle selection is received at block 804. The scan is then completed when retail finance programs that are possibilities for the selected vehicle and the customer data are identified and reported to the dealer, at block 806.

Continuing with FIG. 8 and returning to the description of the eighth, paid reserve calculation, embodiment of the present invention, vehicle scan 800 is followed by the dealer entering the target paid reserve, at block 808. The lender database is then accessed at block 810, and retail finance programs are identified therein as being available to the dealer and his customer. For each retail finance program identified, a paid reserve amount is calculated.

At block 812, the first of the available retail finance programs is identified. Then the method attempts to calculate a minimum interest rate that must be used with the identified retail finance program in order to generate the target paid reserve, at block 814. According to the result of this calculation, the method determines whether the identified retail finance program is able to generate the target paid reserve, at block 816, with a interest rate not more than a maximum interest rate amount, determined by either the lender or the dealer. If a minimum interest rate was calculated, and the identified retail finance program is capable of generating the target paid reserve with that interest rate, as indicated by arrow 818, then the calculated interest rate is stored, such as in a temporary file, at block 820. Next, whether the identified retail finance program was capable of generating the target paid reserve, as indicated by arrow 818, or not, as indicated by arrow 824, the method determines, at block 822, whether there are more available retail finance programs in the lender database. If more retail finance programs are available, as indicated at arrow 826, the interest rate calculation described above continues until the answer generated at block 822 is no, as indicated by arrow 828.

Once the interest rate calculation has been performed for all available retail finance programs in the lender database, then at block 830 the method identifies, for the dealer, which retail finance programs were capable of generating the target reserve and reports the stored interest rates that must be used for each of the capable retail finance programs.

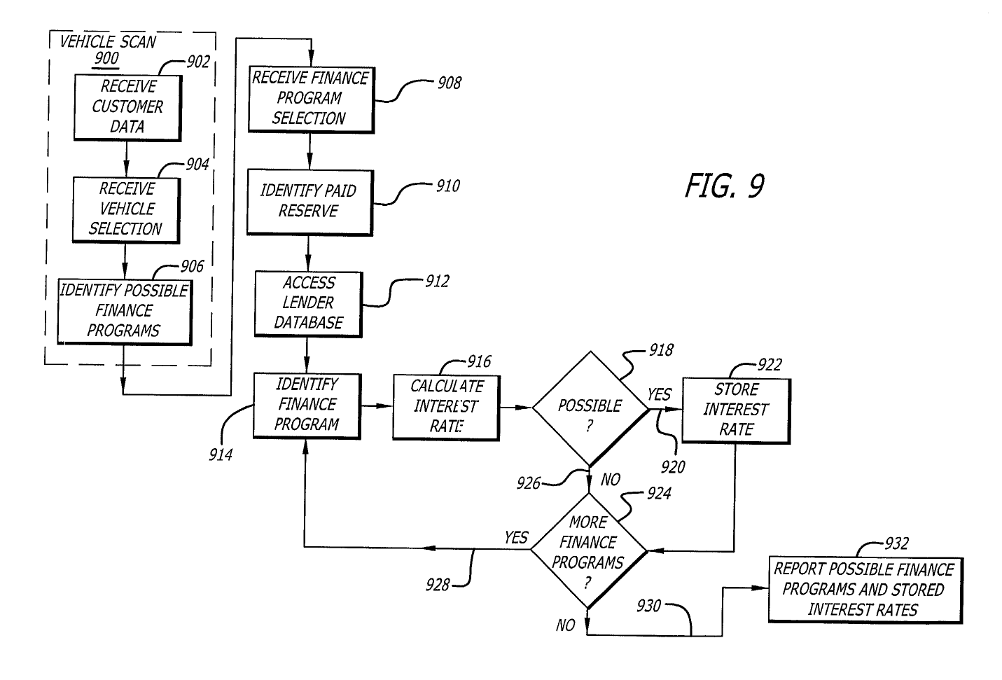

FIG. 9 is a flow diagram illustrating steps of a ninth, fixed paid reserve scan embodiment of the present invention. The ninth embodiment involves a method in which paid reserve amounts generated by each of a plurality of retail finance programs are calculated, and all retail finance programs capable of generating one of the calculated paid reserve amounts, selected by a user, are identified. Specifically, after performing a vehicle scan, a dealer selects one of the identified possible retail finance programs having the most favorable paid reserve amount, and the method of this fifth embodiment identifies which of the unselected possible retail finance programs are also capable of producing that paid reserve.

Vehicle scan 900 includes receiving customer data entered by a dealer at block 902, receiving vehicle selection entered by the dealer at block 904 according to his customer's interest, and identifying, at block 906, which retail finance programs are possible to offer the customer according to the vehicle selection and the customer data. After vehicle scan 900 returns a list of possible retail finance programs, including the amount of paid reserve each will generate, the dealer selects one of them. This selection may be made, for example according to which retail finance program generates the highest amount of paid reserve. After receiving the dealer's retail finance program selection, at block 908, the method identifies, at block 910, the maximum amount of paid reserve that can be generated by the selected retail finance program. The method then includes steps to identify any other available retail finance programs that are capable of producing the identified paid reserve amount.

First, the method accesses the lender database of available retail finance programs, at block 912. At block 914, the first of the available retail finance programs is identified. Then the method attempts to calculate a minimum interest rate that must be used with the identified retail finance program in order to generate the identified paid reserve, at block 916. According to the result of this calculation, the method determines whether the identified retail finance program is able to generate the identified paid reserve, at block 918, with a interest rate not more than a maximum interest rate amount, determined by either the lender or the dealer. If a minimum interest rate was calculated, and the identified retail finance program is capable of generating the identified paid reserve with that interest rate, as indicated by arrow 920, then the calculated interest rate is stored, such as in a temporary file, at block 922. Next, whether the identified retail finance program was capable of generating the identified paid reserve, as indicated by arrow 920, or not, as indicated by arrow 926, the method determines, at block 924, whether there are more available retail finance programs in the lender database. If more retail finance programs are available, as indicated at arrow 928, the interest rate calculation described above continues until the answer generated at block 924 is no, as indicated by arrow 930.

Once the interest rate calculation has been performed for all available retail finance programs in the lender database, then at block 932 the method identifies, for the dealer, which retail finance programs were capable of generating the identified paid reserve and reports the stored interest rates that must be used for each of the capable retail finance programs.

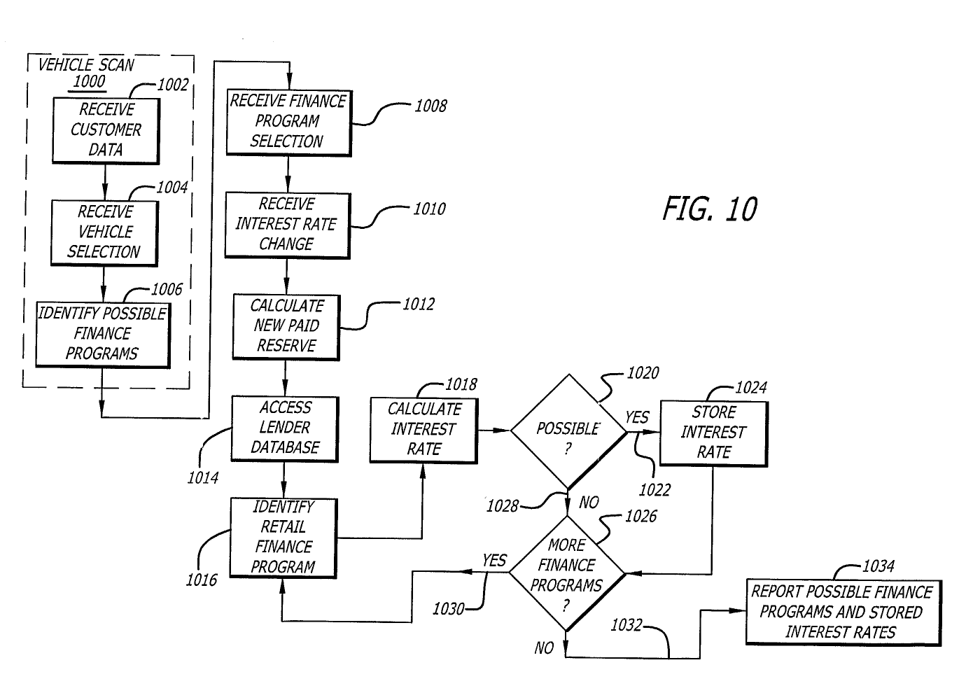

FIG. 10 is a flow diagram illustrating steps of a tenth, rate adjustment calculation embodiment of the present invention. In the method of the tenth embodiment, paid reserve amounts generated by each of a plurality of retail finance programs are initially calculated. Then the paid reserve amount generated by one of the retail finance programs is re-calculated according to a change in the interest rate effectuated by a user. Finally, interest rates required by the rest of the retail finance programs in order for them to generate the re-calculated paid reserve amount are calculated. Specifically, after a user runs a vehicle scan and receives a list of possible retail finance programs, he enters a interest rate change for one of the retail finance programs, and the method of this sixth embodiment re-calculates a new paid reserve that the retail finance program will generate with the new interest rate. Then, the method includes steps for identifying, from all available retail finance programs in the lender database, which retail finance programs are capable of generating the new paid reserve amount.

Vehicle scan 1000 includes receiving customer data entered by a dealer at block 1002, receiving vehicle selection entered by the dealer at block 1004 according to his customer's interest, and identifying, at block 1006, which retail finance programs are possible to offer the customer according to the vehicle selection and the customer data. After vehicle scan 1000 returns a list of possible retail finance programs, including the amount of paid reserve each will generate, the dealer selects one of them at block 1008. This selection may be made, for example according to which retail finance program generates the highest amount of paid reserve, or some other attribute that makes the retail finance program desirable for either the dealer or the customer.

After receiving the dealer's retail finance program selection, at block 1008, the dealer ascertains the interest rate initially established for the selected retail finance program. This interest rate may be a default value established by the lender, or it may be a value that was calculated during vehicle scan 1000 in order to “force” the retail finance program to “fit” the needs of the customer and the dealer. After determining the initial interest rate used in the selected retail finance program, the dealer enters a interest rate change, at block 1010. This change may be, for example, an increase in the interest rate in order to achieve a higher paid reserve amount for the lender. After the interest rate change is received from the dealer's entry, at block 1010, a new paid reserve amount is calculated for the selected retail finance program, using the new interest rate.

The exemplary method next includes steps for accessing the lender database at 1014 and determining whether other available retail finance programs are capable of also producing the new paid reserve. At block 1016, the first of the available retail finance programs is identified. Then the method attempts to calculate a minimum interest rate that must be used with the identified retail finance program in order to generate the new paid reserve, at block 1018. According to the result of this calculation, the method determines whether the identified retail finance program is able to generate the new paid reserve, at block 1020, with a interest rate not more than a maximum interest rate amount, determined by either the lender or the dealer. If a minimum interest rate was calculated, and the identified retail finance program is capable of generating the new paid reserve with that interest rate, as indicated by arrow 1022, then the calculated interest rate is stored, such as in a temporary file, at block 1024. Next, whether the identified retail finance program was capable of generating the new paid reserve, as indicated by arrow 1022, or not, as indicated by arrow 1028, the method determines, at block 1026, whether there are more available retail finance programs in the lender database. If more retail finance programs are available, as indicated at arrow 1030, the interest rate calculation described above continues until the answer generated at block 1026 is no, as indicated by arrow 1032.

Once the interest rate calculation has been performed for all available retail finance programs in the lender database, then at block 1034 the method identifies, for the dealer, which retail finance programs were capable of generating the new paid reserve and reports the stored interest rates that must be used for each of the capable retail finance programs.

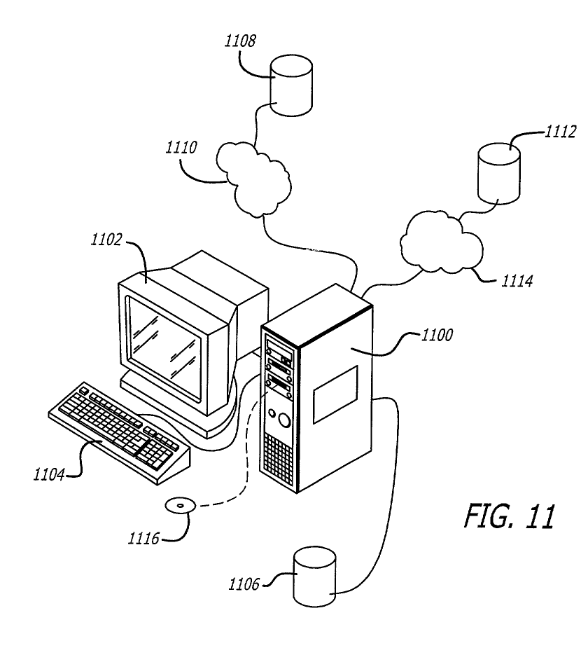

An exemplary hardware system on which various embodiments of the invention may be practiced is illustrated in FIG. 11. It is anticipated that embodiments of the invention will be practiced on a hardware system comprising a computer 1100 having such peripheral devices as an input keyboard 1104, video screen 1102, and a hard drive for data storage 1106. The invention may be practiced with a database, for storage and retrieval of various financial and vehicle data. The database may be a local database 1108 accessible via a local computer network 110, or it may be a remote database 1112 accessible over the Internet 1114. A computer processor may be utilized to carry out calculations according to the invention. It is also anticipated that the invention may be practiced within a network environment. For example, remote databases may be accessed from a dealer location, such as over a telephone or cable data communications line. Software embodiments of calculations of the present invention may be stored on computer readable media, such as CD-ROM 1116 or other media.

The foregoing description of the preferred embodiments of the invention has been presented for the purposes of illustration and description. It is not intended to be exhaustive or to limit the invention to the precise form disclosed. Many modifications and variations are possible in light of the above teaching. For example, a variety of alternative calculations may be utilized according to the concepts of the present invention, as will be recognized by those skilled in the art. Such alternative calculations may include increasing the sale price of a vehicle or handling negative values for customer cash in order to “force” a lease to “fit” the customer's or the dealer's needs. It is intended that the scope of the invention be limited not by this detailed description, but rather by the claims appended hereto.

What is claimed is:

1. A method for selecting, from a plurality of retail finance programs, a retail finance program requiring a lowest monthly payment for a particular vehicle, the method comprising:
receiving financial data associated with the customer;
receiving a target profit amount;
accessing a database stored in a computer system, the database comprising information about a plurality of retail finance programs;
calculating a monthly payment for each of the plurality of retail finance programs, said calculating comprising handling the financial data and the target profit amount as constraints;
comparing the calculated monthly payments; and
reporting which of the plurality of retail finance programs has the lowest calculated monthly payment.

2. A computer system configured to perform the method of claim 1, the computer system comprising:
computer storage media containing software that is programmed according to the method;
a computer processor which, under control of the software, causes the method to be performed;
a peripheral input device for receiving data according to the method; and
a computer display device for reporting results of the performed method to a user of the computer system.

3. Computer readable storage media containing software which, when loaded on a computer and executed, enables the following steps to occur:
the computer receives financial data associated with the customer;
the computer receives a target profit amount;
the computer accesses a database comprising information about a plurality of retail finance programs;
the computer calculates a monthly payment for each of the plurality of retail finance programs, said calculating comprising handling the financial data and the target profit amount as constraints;
the computer compares the calculated monthly payments; and
the computer reports which of the plurality of retail finance programs has the lowest calculated monthly payment.

4. A method for selecting, from a plurality of retail finance programs, a retail finance program that generates a highest profit for a particular vehicle, the method comprising:
receiving financial data associated with the customer;
receiving a target monthly payment amount;
accessing a database stored in a computer system, the database comprising information about a plurality of retail finance programs;
calculating a profit amount for each of the plurality of retail finance programs, said calculating comprising handling the financial data and the target monthly payment amount as constraints;
comparing the calculated profit amounts; and
reporting which of the plurality of retail finance programs has the highest calculated profit amount.

5. A computer system configured to perform the method of claim 4, the computer system comprising:
computer storage media containing software that is programmed according to the method;
a computer processor which, under control of the software, causes the method to be performed;
a peripheral input device for receiving data according to the method; and
a computer display device for reporting results of the performed method to a user of the computer system.

6. Computer readable storage media containing software which, when loaded on a computer and executed, enables the following steps to occur:
the computer receives financial data associated with the customer;
the computer receives a target monthly payment amount;
the computer accesses a database comprising information about a plurality of retail finance programs;
the computer calculates a profit amount for each of the plurality of retail finance programs, said calculating comprising handling the financial data and the target monthly payment amount as constraints;
the computer compares the calculated profit amounts; and
the computer reports which of the plurality of retail finance programs has the highest calculated profit amount.

7. A method for selecting, from a plurality of retail finance programs, a retail finance program requiring a lowest monthly payment for a particular vehicle, the method comprising:
receiving financial data associated with the customer;
receiving a target vehicle price;
receiving a target profit amount;
accessing a database stored in a computer system, the database comprising information about a plurality of retail finance programs;
calculating a monthly payment for each of the plurality of retail finance programs, said calculating comprising handling the financial data, the target vehicle price and the target profit amount as constraints;
comparing the calculated monthly payments; and
reporting which of the plurality of retail finance programs has the lowest calculated monthly payment.

8. The method of claim 7 wherein said target profit amount comprises:
a target paid reserve amount; and
a target warranty profit amount.

9. A computer system configured to perform the method of claim 7, the computer system comprising:
computer storage media containing software that is programmed according to the method;
a computer processor which, under control of the software, causes the method to be performed;
a peripheral input device for receiving data according to the method; and
a computer display device for reporting results of the performed method to a user of the computer system.

10. Computer readable storage media containing software which, when loaded on a computer and executed, enables the following steps to occur:
the computer receives financial data associated with the customer;
the computer receives a target vehicle price;
the computer receives a target profit amount;
the computer accesses a database comprising information about a plurality of retail finance programs;
the computer calculates a monthly payment for each of the plurality of retail finance programs, said calculating comprising handling the financial data, the target vehicle price and the target profit amount as constraints;
the computer compares the calculated monthly payments; and
the computer reports which of the plurality of retail finance programs has the lowest calculated monthly payment.

11. A method for selecting, from a plurality of retail finance programs, a retail finance program that generates a highest profit for a particular vehicle, the method comprising:
receiving financial data associated with the customer;
accessing a database stored in a computer system, the database comprising information about a plurality of retail finance programs;
calculating a profit amount for each of the plurality of retail finance programs, said calculating comprising handling the financial data as a constraint;
comparing the calculated profit amounts; and
reporting which of the plurality of retail finance programs has the highest calculated profit amount.

12. A computer system configured to perform the method of claim 11, the computer system comprising:
computer storage media containing software that is programmed according to the method;
a computer processor which, under control of the software, causes the method to be performed;
a peripheral input device for receiving data according to the method; and
a computer display device for reporting results of the performed method to a user of the computer system.

13. Computer readable storage media containing software which, when loaded on a computer and executed, enables the following steps to occur:
the computer receives financial data associated with the customer;
the computer accesses a database comprising information about a plurality of retail finance programs;
the computer calculates a profit amount for each of the plurality of retail finance programs, said calculating comprising handling the financial data as a constraint;
the computer compares the calculated profit amounts; and
the computer reports which of the plurality of retail finance programs has the highest calculated profit amount.

14. A method for selecting, from a plurality of retail finance programs, a retail finance program that requires the lowest monthly payment, the method comprising:
receiving a first input representing a target profit;
receiving a second input representing an amount of cash available for loan inception fees;
receiving financial information about a customer;
accessing a database stored in a computer system, the database comprising information about a plurality of retail finance programs; and
identifying, for each of the vehicles, the retail finance program requiring the identified lowest monthly payment.

15. The method of claim 14 wherein the identifying comprises:
calculating a monthly payment required by each of the plurality of retail finance programs for each of a plurality of vehicles, the monthly payment constrained by the target profit, the amount of cash available for retail finance inception fees and the financial information about the customer; and
for each of the vehicles, comparing the calculated monthly payments required by each of the plurality of retail finance programs and selecting the lowest monthly payment;

16. A computer system configured to perform the method of claim 14, the computer system comprising:
computer storage media containing software that is programmed according to the method;
a computer processor which, under control of the software, causes the method to be performed;
a peripheral input device for receiving data according to the method; and
a computer display device for reporting results of the performed method to a user of the computer system.

17. Computer readable storage media containing software which, when loaded on a computer and executed, enables the following steps to occur:
the computer receives a first input representing a target profit;
the computer receives a second input representing an amount of cash available for loan inception fees;
the computer receives financial information about a customer;
the computer accesses a lender database comprising information about a plurality of retail finance programs; and
the computer identifies, for each of the vehicles, the retail finance program requiring the identified lowest monthly payment.

18. The method of claim 11 wherein the receiving financial information about a customer comprises:
collecting information about the customer;
entering the collected information in a computer input device; and
transmitting the entered, collected information from the computer input device to a computer processing device, the computer processing device being configured to perform the remaining steps of the method of claim 11.

19. The method of claim 18 wherein the computer input device is in a location remote to the computer processing device.

20. The method of claim 19 wherein the collecting and entering are performed by a first user, and the computer processing device is operated by a second user.

21. A method for selecting, from a plurality of retail finance programs, a retail finance program for each of a plurality of customers, the method comprising:
collecting information about a first customer;
entering the collected information about the first customer in a first computer input device;
collecting information about a second customer;
entering the collected information about the second customer in a second computer input device;
transmitting the entered, collected information from the first and second computer input devices to a computer processing device, the computer processing device being configured to select, from a plurality of retail finance programs, a retail finance program according to a customer's information; and
causing the computer processing device to select a retail finance program for the first customer and a retail finance program for the second customer.

22. The method of claim 21 wherein the first computer input device and the second computer input device are located remote to each other.

23. The method of claim 21 wherein the first computer input device and the second computer input device are located remote to the computer processing device.

24. The method of claim 21 wherein the collecting and entering information about a first customer is performed by a first user and the causing the computer processing device to select a retail finance program for the first customer is performed by a second user.

25. The method of claim 24 wherein the collecting and entering information about a second customer is performed by a third user and the causing the computer processing device to select a retail finance program for the second customer is performed by the second user.

26. A method for selecting, from a plurality of retail finance programs, a retail finance program that generates the largest profit, the method comprising:
receiving a first input representing a target monthly payment amount;
receiving a second input representing an amount of cash available for loan inception fees;
receiving financial information about a customer;
accessing a database stored in a computer system, the database comprising information about a plurality of retail finance programs; and
identifying, for each of the vehicles, the retail finance program generating the highest profit.

27. The method of claim 26 wherein the identifying comprises:
calculating a profit generated by each of the plurality of retail finance programs for each of a plurality of vehicles, the profit constrained by the target monthly payment, the amount of cash available for retail finance inception fees and the financial information about the customer; and
for each of the vehicles, comparing the calculated profit generated by each of the plurality of retail finance programs and selecting the highest profit; and

28. The method of claim 26 wherein the receiving financial information about a customer comprises:
collecting information about the customer;
storing the collected information in a first computer storage device; and
transmitting the stored, collected information from the first computer storage device to a central computer storage device, the central computer storage device being configured to perform the remaining steps of the method of claim 26.

29. A computer system configured to perform the method of claim 26, the computer system comprising:
computer storage media containing software that is programmed according to the method;
a computer processor which, under control of the software, causes the method to be performed;
a peripheral input device for receiving data according to the method; and
a computer display device for reporting results of the performed method to a user of the computer system.

30. Computer readable storage media containing software which, when loaded on a computer and executed, enables the following steps to occur:
the computer receives a first input representing a target monthly payment amount;
the computer receives a second input representing an amount of cash available for loan inception fees;
the computer receives financial information about a customer;
the computer accesses a lender database comprising information about a plurality of retail finance programs; and
the computer identifies, for each of the vehicles, the retail finance program generating the highest profit.

31. A method for selecting, from a plurality of retail finance programs, a retail finance program that generates the largest profit for a particular monthly payment amount, the method comprising:
receiving an input representing an amount of cash available for loan inception fees;
receiving financial information about a customer;
accessing a database stored in a computer system, the database comprising information about a plurality of retail finance programs; and
identifying, for each of the vehicles, the retail finance program generating the highest profit for each of the monthly payment amounts.

32. The method of claim 31 wherein the identifying comprises:
calculating a set of profits generated by each of the plurality of retail finance programs for each of a plurality of vehicles, the set of profits comprising:
a profit calculated for each of a set of monthly payment amounts, each profit and each monthly payment amount constrained in the calculating by the amount of cash available for retail finance inception fees and the financial information about the customer;
the calculating comprising considering an upward adjustment in a sales price of the vehicle; and
for each of the vehicles, and each of the monthly payment amounts, comparing the calculated profit generated by each of the plurality of retail finance programs and selecting the highest profit; and

33. The method of claim 31 wherein the receiving financial information about a customer comprises:
collecting information about the customer;
storing the collected information in a first computer storage device; and
transmitting the stored, collected information from the first computer storage device to a central computer storage device, the central computer storage device being configured to perform the remaining steps of the method of claim 31.

34. A computer system configured to perform the method of claim 31, the computer system comprising:
computer storage media containing software that is programmed according to the method;
a computer processor which, under control of the software, causes the method to be performed;
a peripheral input device for receiving data according to the method; and
a computer display device for reporting results of the performed method to a user of the computer system.

35. Computer readable storage media containing software which, when loaded on a computer and executed, enables the following steps to occur:
the computer receives an input representing an amount of cash available for loan inception fees;
the computer receives financial information about a customer;
the computer accesses a lender database comprising information about a plurality of retail finance programs; and
the computer identifies, for each of the vehicles, the retail finance program generating the highest profit for each of the monthly payment amounts.

36. A method for selecting, from a plurality of retail finance programs, a retail finance program capable of generating a specified paid reserve amount and calculating a interest rate that causes the selected retail finance program must use to generate the specified paid reserve amount, the method including:
identifying a plurality of retail finance programs for which a customer qualifies according to customer information and a particular vehicle;
receiving an input representing a target paid reserve amount;
accessing a database stored in a computer system, the database comprising information about a plurality of retail finance programs;
calculating, for each of the plurality of retail finance programs, a minimum interest rate that, when applied to the retail finance program, causes the retail finance program to generate the target paid reserve amount;
the calculating including considering an upward adjustment in a sales price of the vehicle; and
reporting which of the plurality of retail finance programs is capable of generating the target paid reserve amount and, for each of the capable retail finance programs, identifying the calculated minimum interest rate that causes the retail finance program to generate the target paid reserve amount.

37. A computer system configured to perform the method of claim 36, the computer system comprising:
computer storage media containing software that is programmed according to the method;
a computer processor which, under control of the software, causes the method to be performed;
a peripheral input device for receiving data according to the method; and
a computer display device for reporting results of the performed method to a user of the computer system.

38. Computer readable storage media containing software which, when loaded on a computer and executed, enables the following steps to occur:
the computer identifies a plurality of retail finance programs for which a customer qualifies according to customer information and a particular vehicle;
the computer receives an input representing a target paid reserve amount;
the computer accesses a database comprising information about a plurality of retail finance programs;
the computer calculates, for each of the plurality of retail finance programs, a minimum interest rate that, when applied to the retail finance program, causes the retail finance program to generate the target paid reserve amount;
the calculating including considering an upward adjustment in a sales price of the vehicle; and
the computer reports which of the plurality of retail finance programs is capable of generating the target paid reserve amount and, for each of the capable retail finance programs, identifying the calculated minimum interest rate that causes the retail finance program to generate the target paid reserve amount.

39. The method of claim 36 wherein the receiving an input representing a target paid reserve amount comprises:
receiving an input representing a selection of a retail finance program from a plurality of retail finance programs; and
identifying the paid reserve amount that is generated by the selected retail finance program.

40. A computer system configured to perform the method of claim 39, the computer system comprising:
computer storage media containing software that is programmed according to the method;
a computer processor which, under control of the software, causes the method to be performed;
a peripheral input device for receiving data according to the method; and
a computer display device for reporting results of the performed method to a user of the computer system.

41. Computer readable storage media containing software which, when loaded on a computer and executed, enables the following steps to occur:
the computer identifies a plurality of retail finance programs for which a customer qualifies according to customer information and a particular vehicle;
the computer receives an input representing a selection of a retail finance program from a plurality of retail finance programs; and
the computer identifies the paid reserve amount that is generated by the selected retail finance program.
the computer accesses a database comprising information about a plurality of retail finance programs;
the computer calculates, for each of the plurality of retail finance programs, a minimum interest rate that, when applied to the retail finance program, causes the retail finance program to generate the target paid reserve amount;
the calculating including considering an upward adjustment in a sales price of the vehicle; and
the computer reports which of the plurality of retail finance programs is capable of generating the target paid reserve amount and, for each of the capable retail finance programs, identifying the calculated minimum interest rate that causes the retail finance program to generate the target paid reserve amount.

42. The method of claim 36 wherein the receiving an input representing a target paid reserve amount comprises:
receiving an input representing a selection of a retail finance program from a plurality of retail finance programs, the selected retail finance program having a first interest rate and a first paid reserve amount;
receiving a second interest rate different than the first interest rate;
calculating a second paid reserve amount for the selected retail finance program according to the second interest rate.

43. A computer system configured to perform the method of claim 42, the computer system comprising:
computer storage media containing software that is programmed according to the method;
a computer processor which, under control of the software, causes the method to be performed;
a peripheral input device for receiving data according to the method; and
a computer display device for reporting results of the performed method to a user of the computer system.

44. Computer readable storage media containing software which, when loaded on a computer and executed, enables the following steps to occur:
the computer identifies a plurality of retail finance programs for which a customer qualifies according to customer information and a particular vehicle;
the computer receives an input representing a selection of a retail finance program from a plurality of retail finance programs, the selected retail finance program having a first interest rate and a first paid reserve amount;
the computer receives a second interest rate different than the first interest rate;
the computer calculates a second paid reserve amount for the selected retail finance program according to the second interest rate.
the computer accesses a database comprising information about a plurality of retail finance programs;
the computer calculates, for each of the plurality of retail finance programs, a minimum interest rate that, when applied to the retail finance program, causes the retail finance program to generate the target paid reserve amount;
the calculating including considering an upward adjustment in a sales price of the vehicle; and
the computer reports which of the plurality of retail finance programs is capable of generating the target paid reserve amount and, for each of the capable retail finance programs, identifying the calculated minimum interest rate that causes the retail finance program to generate the target paid reserve amount.
